(19) United States
(12) Patent Application Publication
(10) Pub. No.: US 2014/0297586 A1
(43) Pub. Date: Oct. 2, 2014

(54) DEVICE AND METHOD FOR CLOUD FILE MANAGEMENT

(71) Applicant: Pantech Co., Ltd., Seoul (KR)

(72) Inventor: Jong-Woo KIM, Seoul (KR)

(73) Assignee: Pantech Co., Ltd., Seoul (KR)

(21) Appl. No.: 14/026,890

(22) Filed: Sep. 13, 2013

(30) Foreign Application Priority Data
Mar. 27, 2013 (KR) 10-2013-0032996

(51) Int. Cl. G06F 17/30

(52) U.S. Cl. CPC G06F 17/30174
USPC 707/610; 707/827

(57) ABSTRACT

Provided are a file management method and a mobile device to perform file management. The file management method includes receiving a request to retrieve a first file stored in the mobile device, determining whether a second file corresponding to the first file is stored in a cloud storage server, generating the second file for storage in the cloud storage server if the second file is determined not to be stored in the cloud storage server, and outputting cloud federation information corresponding to the first file if the second file is determined to be stored in the cloud storage server, in which the second file is capable of being unedited regardless of the first file.

### CROSS-REFERENCE TO RELATED APPLICATION

This application claims priority to and the benefit under 35 U.S.C. §119(a) of Korean Patent Application No. 10-2013-0032996, filed on Mar. 27, 2013, the entire disclosure of which is incorporated herein by reference for all purposes.

### BACKGROUND

1. Field

The following description relates to file management of a device, and more particularly, a technology for managing files stored in a device using cloud storage.

2. Discussion of the Background

It is easy to find people carrying a portable computing device, which is equipped with a mobile Operating System (OS). Portable computing devices may include a smart phone, a tablet computer, or a smart mobile device, which may generally be referred to as a mobile device. Performance of mobile devices has improved due to development of telecommunications technology. Further, various hardware modules have come to be installed in mobile devices due to a new trend called digital convergence. Accordingly, a user is able to utilize various hardware modules installed in the mobile device and install many application programs in the mobile devices for various purposes.

With the improved performance and increased uses of a mobile device, a user can store many files in the mobile device. For example, not only digital content, such as videos, music files, and pictures, but also application programs can be stored in the mobile device. The mobile device has an embedded memory and may also be connected to an external memory. Capacity of both the embedded memory and the external memory has expanded. However, a user may be unable or may not seek to store every piece of content or file in the memory due to its limitation in storage size. Therefore, it may be desirable to more effectively manage files stored in the mobile device.

If the files stored in the mobile device are not managed effectively, there may be a shortage of memory to store additional files. In such case, a user may secure memory capacity by deleting some of the existing files stored in the memory. For example, if there is an unnecessary file stored in the mobile device, a user may delete the file to secure or increase memory availability. However, if all the files stored in the memory are essential or if it is uncertain which file is essential, the user may have difficulty in deciding which file to delete, and may seek to store an existing file or a new file in additional storage devices.

Cloud storage service is one of methods to back up a file stored in a mobile device, and is increasingly drawing more attention. Using the cloud storage service, it may be possible to store files in a memory space assigned in a cloud storage server as an extensible external memory of the mobile device. For example, a user may be able to store a copy of the file to be deleted in a cloud storage server and then delete the local file. In another example, the user may be able to check whether a copy of the file to be deleted locally is stored in a cloud storage server, and then delete the local file only when it is determined that the copy of the file is stored in the cloud storage server.

In this way, the user may be able to store a copy of the file to be deleted locally in a cloud storage server or delete a file stored in the cloud storage server. In the former case, the user has to store the file to be deleted in the cloud storage server before deleting the file. In the latter case, the user has to access various cloud storage servers, such that the user may determine whether the file to be deleted is stored in a corresponding cloud storage server.

### SUMMARY

Exemplary embodiments of the present invention provide a mobile device and method for cloud file management.

Additional features of the invention will be set forth in the description which follows, and in part will be apparent from the description, or may be learned by practice of the invention.

Exemplary embodiments of the present invention provide a file management method including receiving a request for deleting a first file stored in a mobile device; determining whether a second file corresponding to the first file is stored in a cloud storage server; configuring the second file for storage in the cloud storage server based on the determination; and deleting the first file from the mobile device, in which the second file is retained in the cloud storage server after the first file is deleted.

Exemplary embodiments of the present invention provide a mobile device including a memory unit to store a first file; a communication unit to receive a request to delete the first file; and a control unit to determine whether a second file corresponding to the first file is stored in a cloud storage server, to configure the second file for storage in the cloud storage server based on the determination, and to delete the first file, in which the second file is retained in the cloud storage server after the first file is deleted.

Exemplary embodiments of the present invention provide a file management method including receiving a request for deleting a first file stored in a mobile device; determining whether a second file corresponding to the first file is stored in a cloud storage server; generating the second file for storage in the cloud storage server if the second file is determined not to be stored in the cloud storage server; modifying the storage type of the second file for retaining the second file regardless of the first file if the second file is determined to be stored in the cloud storage server; and deleting the first file from the mobile device, in which the second file is retained in the cloud storage server after the first file is deleted.

Exemplary embodiments of the present invention provide a mobile device capable of providing a cloud federation service, the mobile device including a memory unit to store a first file; a cloud federation determination unit to determine whether the first file is synchronized with a second file stored in a cloud storage server, the second file corresponding to the first file; and a federation information output control unit to control cloud federation information to be output based on the determination.

Exemplary embodiments of the present invention provide a file management method for providing a cloud federation service in a mobile device, the file management method including receiving a request to retrieve a first file stored in the mobile device; determining whether a second file is stored in a cloud storage server, the second file corresponding to the first file; and outputting cloud federation information corresponding to the first file based on the determination.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a system for providing a cloud storage service according to an exemplary embodiment of the present invention.

FIG. 2 is a block diagram illustrating a configuration of a mobile device capable of providing cloud federation according to an exemplary embodiment of the present invention.

FIG. 3 is a block diagram illustrating a data format of a signal which is transmitted and/or received between a cloud federation unit and a cloud storage server according to an exemplary embodiment of the present invention.

FIG. 4A is a diagram illustrating cloud federation information along with a corresponding file after the corresponding file is executed according to an exemplary embodiment of the present invention.

FIG. 4B is a diagram illustrating cloud federation information regarding each item included in a file list along with the file list according to an exemplary embodiment of the present invention.

FIG. 4C is a diagram illustrating cloud federation information regarding each item included in a file list along with the file list according to an exemplary embodiment of the present invention.

FIG. 5A is a diagram illustrating a request to delete a file shown in FIG. 4A according to an exemplary embodiment of the present invention.

FIG. 5B is a diagram illustrating a screen which is displayed after the request to delete the file shown in FIG. 5A is received according to an exemplary embodiment of the present invention.

FIG. 6A is a diagram illustrating a request to delete all the files included in a list shown in FIG. 4C according to an exemplary embodiment of the present invention.

FIG. 6B and FIG. 6C are diagrams illustrating a screen which is displayed after receiving the request to delete all files shown in FIG. 6A according to exemplary embodiments of the present invention.

FIG. 6D and FIG. 6E are diagrams illustrating a request to delete some of the files included in a list shown in FIG. 4C according to exemplary embodiments of the present invention.

FIG. 6F is a diagram illustrating a screen which is displayed after receiving the request to delete some of the files shown in FIG. 6D according to an exemplary embodiment of the present invention.

FIG. 7 is a diagram illustrating a format of cloud federation file database according to an exemplary embodiment of the present invention.

FIG. 8 is a flow chart illustrating a file management method of a mobile device according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

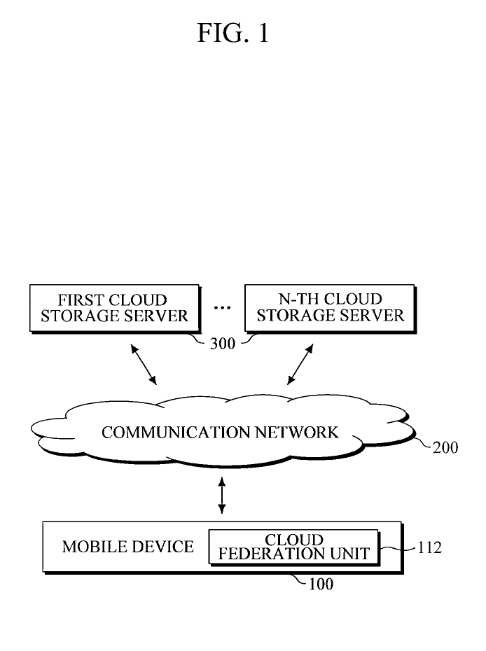

FIG. 1 is a diagram illustrating a configuration of a system for a cloud storage service according to an exemplary embodiment of the present invention.

Referring to FIG. 1, the system includes a mobile device 100 and one or more cloud storage servers 300. The mobile device 100 may refer to a user device, which utilizes s a cloud storage service. One or more cloud storage servers 300 may provide a predetermined memory space for the mobile device 100. The cloud storage service may allow storage of one or more files, which may be retrieved, accessed, and/or modified by the mobile device 100 having appropriate rights. According to aspects of the invention, the file may not be limited to be a document, and may include, without limitation, a photo, a picture, a music file or a video data file, a program file, such as an application file, and the like. The mobile device 100 and one or more of the cloud storage servers 300 may be able to communicate with each other via a predetermined communication network 200. According to exemplary embodiments of the present invention, the communication network 200 may not be limited to a specific type, a specific feature, or a specific communication technique.

One or more cloud storage servers 300 may provide a cloud storage service individually. Of course, the same service provider may provide a cloud storage service using the plurality of cloud storage servers 300. A cloud storage server 300 may provide a predetermined memory space for the mobile device 100. The cloud storage server 300 may include, without limitation, Apple's i-Cloud® or a server operated by an Internet service provider, for example an Internet portal service provider and a web storage service provider, who may provide a cloud storage service. According to exemplary embodiments of the present invention, the cloud storage server 300 is not limited to a specific configuration.

In response to a request from the mobile device 100, the cloud storage server 300 may store a copy of a local file, which may also be stored in the mobile device 100, in an assigned memory space. In addition, in response to a request from the mobile device 100, the cloud storage server 300 may perform basic file management operations, such as deleting or editing a file stored in the cloud storage server 300 or a server file. In addition, in response to a request received from a different computer device other than the mobile device 100, the cloud storage server 300 may store a requested file in an assigned memory space and perform file management operations, such as deleting or editing the stored file. Further, a change in the cloud storage server 300 or a change in a file stored in the storage server 300, or server file, may be notified to the mobile device 100 and relevant data related to the change may be transmitted from the mobile device 100 from the cloud storage server 300. According to aspects of the invention, local file may, without limitation, refer to a file stored in the mobile device 100, and server file may, without limitation, refer to a file corresponding to the local file stored in the cloud storage server 300. The server file may also be referred to as a copy of a local file or a file to be deleted.

For the purpose of interworking between the mobile device 100 and one or more cloud storage servers 300, the mobile device 100 may include one or more cloud federation units 112. Referring to FIG. 1, the mobile device 100 includes a cloud federation unit 112, however, aspects of the invention are not limited thereto, such that a mobile device may include several cloud federation units 112. Thus, the mobile device 100 interworking with one or more cloud storage servers 300 may include one or more cloud federation units 112 corresponding to the plurality of cloud storage servers 300. The cloud federation unit 112 may be a cloud application, which may be provided by an individual cloud storage service provider to be installed in the mobile device 100, or an operation of the cloud application. However, aspects of the invention are not limited thereto. Operation of the cloud federation unit 112 will be described in more detail in following.

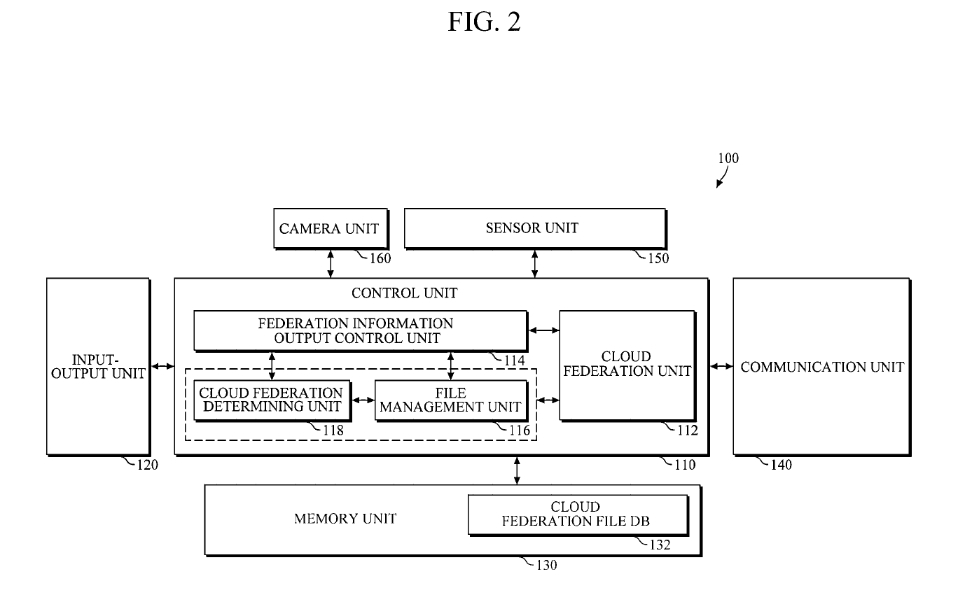

FIG. 2 is a block diagram illustrating a configuration of a mobile device capable of providing a cloud federation service according to an exemplary embodiment of the present invention.

A mobile device 100 of FIG. 2 may include, without limitation, a smart phone or a tablet computer, but is not limited thereto. Hereinafter, a mobile device capable of providing a cloud federation service according to exemplary embodiments of the present invention will be described in detail with reference to FIG. 1 and FIG. 2.

As shown in FIG. 2, the mobile device 100 of FIG. 2 includes a control unit 110, an input-output unit 120, a memory unit 130, a communication unit 140, a sensor unit 150, and a camera unit 160. In addition, the control unit 110 includes a cloud federation unit 112, a federation information output control unit 114, a file management unit 116, and a cloud federation determining unit 118. The mobile device 100 of FIG. 2 may be a mobile device capable of providing a cloud federation service. However, aspects of the invention are not limited thereto, such that a mobile device capable of providing a cloud federation service may include only some of the units illustrated in FIG. 2 or include additional units not included herein. More specifically, a mobile device capable of providing a cloud federation service may not include one or more of the units illustrated in FIG. 2. For example, a mobile device capable of providing a cloud federation service may not include the sensor unit 150 and/or the camera unit 160. In addition, a mobile device capable of providing a cloud federation service may include additional units that may perform a specific operation, and the additional units may vary according to a type and/or operation of the mobile device in which they may be installed. For example, a mobile device capable of providing a cloud federation service may further include, without limitation, at least one of a vibration generating module, a Global Positioning System (GPS) module, a digital multimedia broadcasting (DMB) module, a wired communication module, and a power supply unit.

The control unit 110 may manage, process and/or control one or more operations of the mobile device 100. For example, the control unit 110 may control an operation or perform signal processing to execute a predetermined module or application, such as playing a game, playing back a multimedia file, or executing an application, in the mobile device 100. In addition, the control unit 110 may control the communication unit 140 to enable the mobile device 100 to perform communication, such as data communication and/or a voice calling operation, with a server (e.g., the cloud storage server 300 in FIG. 1) or a different mobile device. Furthermore, the control unit 110 may process a transmitted and/or received signal. The control unit 110 may process a visual, audio, and/or mechanical input signal received through an input unit of the input-output unit 120, the sensor unit 150 or the camera unit 160. Further, the control unit 110 may control an output unit of the input-output unit 120 to output at least one of a visual, audio, and/or mechanical signal as a result of processing an input signal in the control unit 100. In addition, the control unit 110 may store, in the memory unit 130, a file generated by a different unit, a file received via the communication unit 140, and/or a file which may be generated by execution of an application, and may perform one or more file management operations, such as fetching a file stored in the memory unit 130 and/or updating a file.

The control unit 110 may control the mobile device 100 to manage a file stored in the memory unit 130 with interworking with a cloud storage server (e.g., the cloud storage server 300 in FIG. 1). In more detail, the control unit 110 may store a file in the memory unit 130 and may perform file management operations, including changing or deleting the stored file. In addition, the control unit 110 may control all or some of the files stored in the memory unit 130 to be stored in one or more cloud storage servers 300. In addition, the control unit 110 may control cloud federation information regarding a file stored in the memory unit 130 to be output through an output unit of the input-output unit 120.

Referring to FIG. 2, the control unit 110 includes the cloud federation unit 112, the federation information output control unit 114 and the file management unit 116. In addition, the control unit 110 further includes a cloud federation determination unit 118. The various units of the control unit 110 may be logically distinctive from each other. Accordingly, two or more of the cloud federation unit 112, the federation information output control unit 114, the file management unit 116, and the cloud federation determination unit 118 may be physically combined as a singular unit to be used. For example, the cloud federation determination unit 118 may be a subunit included in the file management unit 116 or may be a separate unit, independent of the file management unit 116. In addition, operations of the elements, units, or subunits of the control unit 110, which will be described in following, may be distinguishable, however, aspects of the invention are not limited thereto, such that any operation may be performed by a different element other than the described element or may be performed by a combination of two or more of the elements.

The cloud federation unit 112 may control the memory unit 130 and/or the cloud storage server 300 to interwork with each other. More specifically, the cloud federation unit 112 may control a file to be stored in the cloud storage server 300. According to aspects of the invention, controlling the memory unit 130 and the cloud storage server 300 to interwork with each other or storing a file in the cloud storage server 300 may include, without limitation, storing, changing or deleting a specific file with respect to the memory unit 130 and then storing, changing or deleting the specific file with respect to the cloud storage server 300. In addition, controlling the memory unit 130 and the cloud storage server 300 to interwork with each other or storing g a file in the cloud storage server 300 may also include, without limitation, storing, changing or deleting a specific file with respect to the cloud storage server 300 and then storing, changing or deleting the specific file with respect to the memory unit 130.

One or more operations of the cloud federation unit 112 may be performed by a cloud application, which may be provided by a cloud storage service provider to be installed in the mobile device 100. However, aspects of the invention are not limited thereto. For example, some of the operations of the cloud federation unit 112 may not be supported by a cloud application. An operation that the cloud application may not support may be realized as an additional application or an operation of the control unit 110.

According to aspects of the invention, there may be two or more methods by which the cloud federation unit 112 may control a copy of the file stored in the memory unit 130 to be stored in the cloud storage server 300. In more detail, a copy of the file stored in the memory unit 130 may be generated and stored in the cloud storage server 300 using a synchronization method or a backup method. When a file stored in the memory unit 130 is deleted or changed, a file synchronized with the cloud storage server 300 may correspondingly be deleted or changed in the cloud storage server 300, whereas a file backed-up to the cloud storage server 300 may not be deleted or changed in the cloud storage server 300 upon synchronization. In addition, when a user accesses the cloud storage server 300 using a different computing device other than the mobile device 100 to store a new file and/or change or delete a stored file, there may be no change in a file stored in the memory unit 130 if the file is backed-up to the cloud storage server 300. Further, a new file stored in the memory unit 130 may be stored in the cloud storage server 300 or a file previously stored in the memory unit 130 may be deleted or changed in the cloud storage server 300 if the corresponding file is synchronized with the cloud storage server 300.

The mobile device 100 and the cloud storage server 300 may interwork with each other according to an arbitrarily selected synchronization method and/or the backup method, or according to one of the synchronization method and/or the backup method selected by a service policy of a cloud storage service provider. In either scenario, the cloud federation unit 112 may be able to control a file that is stored, changed or deleted in the memory unit 130 to be stored, changed or deleted in the cloud storage server 300 through the communication unit 140. According to aspects of the invention, the communication unit 140 may be a module which transmits and/or receives, from the cloud storage server 300, a request, information or data that may be used to store a file in the cloud storage server 300.

If the mobile device 100 interworks with two or more cloud storage servers 300, a file may be stored in one or more cloud storage servers 300 differently according to a type of a corresponding cloud storage server 300. According to an exemplary embodiment of the present invention, a file stored in the memory unit 130 may be stored in the cloud storage server 300 differently according to a type of the file. For example, if a file has a high significance level, the file may be backed-up to the cloud storage server 300, but, if a file has a low significance level, the file may be synchronized with the cloud storage server 300. However, aspects of the invention are not limited thereto, such that the file may be backed-up or synchronized according to different conditions or attributes.

The cloud federation unit 112 may control the communication unit 140 to change a storage type of a file stored in the memory unit 130. In more detail, the cloud federation unit 112 may change a storage type of a file from a synchronization type to a backup type or from a backup type to a synchronization type. For example, if the file management unit 116 receives a request from a user to delete a file which is synchronized with the cloud storage server 300, the cloud federation unit 112 may automatically change the storage type of the file to a backup type according to a reference condition or in response to a user's request.

The cloud federation unit 112 may reflect or communicate a change in the file stored in the memory unit 130 to the cloud storage server 300. For example, if a new file is stored in the memory unit 130, the cloud federation unit 112 may control a copy of the new file to be generated and stored in the cloud storage server 300 through the communication unit 140. Further, the copy of the new file may be stored in the cloud storage server 300 using any one of the synchronization method and the backup method, as described above.

In addition, if a file synchronized with the cloud storage server 300 is changed or deleted, the cloud federation unit 112 may control the corresponding file stored in the cloud storage server 300 to be changed or deleted. Further, the cloud federation unit 112 may perform the above-described operation when an explicit request is received from a user or may perform the above-described operation after changing a storage type of the file into a backup type, thereby reducing the likelihood of the file from being changed or deleted. In addition, if a file is backed-up to the cloud storage server 300, the file may not be deleted or changed in the cloud storage server 300 even if the corresponding file is locally deleted or changed in the memory unit 130. However, the cloud federation unit 112 may control a file to be changed or deleted in the cloud storage server 300, if an explicit request is received from a user.

Further, although not shown in FIG. 2, the mobile device may include additional hardware components, such as one or more processors and the like. Also, the units, modules, elements, applications, and components of the apparatuses, systems, and/or mobile devices herein described, may include hardware and software, may also include firmware, to perform various operations of the devices including those described herein, may be combined or remain separate, and may be stored in one or more storage devices or computer-readable media. And, although described herein as a mobile device, aspects need not be limited thereto such that the mobile device may be a cellular telephone, a smartphone, a tablet computer, a laptop computer, a desktop computer, and the like.

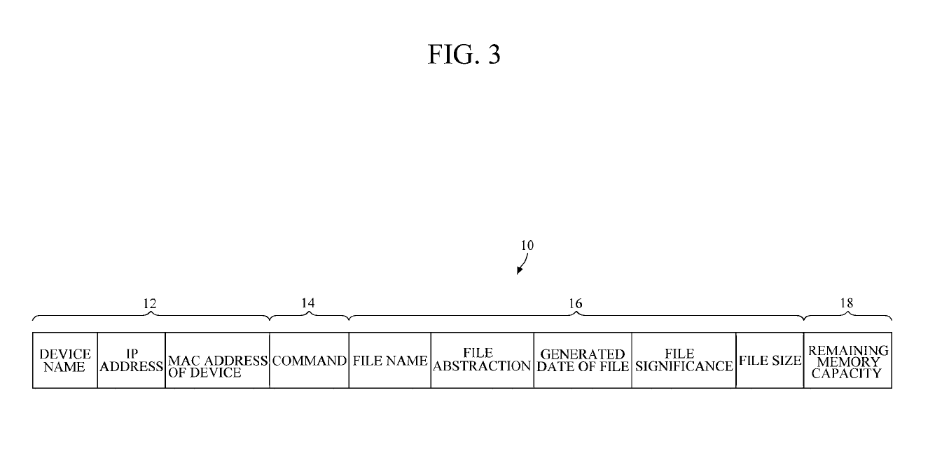

FIG. 3 is a block diagram illustrating a data format of a signal transmitted and/or received between a cloud federation unit and a cloud storage server according to an exemplary embodiment of the present invention. The signal transmitted between the cloud federation unit and the cloud storage server may be used to enable a mobile device and a cloud storage server to interwork with each other.

The data format illustrated in FIG. 3 is an exemplary embodiment, and aspects of the present invention are not limited thereto. Referring to FIG. 3, data 10, which may be transmitted and/or received between a cloud federation unit 112 and a cloud storage server 300, includes a device identification information area 12, a command area 14, a file information area 16 and a device state information area 18, which may be used to show specific attributes or information for interworking. In more detail, the device identification information 12 may be an area containing information used to identify a device, and may include a mobile device identification (ID) or a device name, an Internet Protocol (IP) address, and a mobile device media access control (MAC) address. The command area 14 may be an area containing specific attributes or information for interworking, and may include commands such as generation, deletion, and modification. The file information area 16 may be an area containing information regarding a file to be synchronized, and may include a file name, a file abstraction, a generated date of a file, significance of the file and a file size. In addition, the device state information area 18 may be an area containing information regarding a current state of a memory capacity of a device, such as a remaining capacity of memory. As described in the following, data transmitted and/or received between the mobile device 100 and the cloud storage server 300 may be utilized by the mobile device 100 to generate a cloud federation file database 132.

Information regarding a new file stored in a memory unit 130 or information regarding a change in a file previously stored in the memory unit 130 may be transmitted from the file management unit 116 to the cloud federation unit 112. Further, when there is a change in a file stored in the memory unit 130, the file management unit 116 may transmit information regarding the change to the cloud federation unit 112. However, aspects of the present invention are not limited thereto. For example, although not illustrated in FIG. 3, an additional unit (e.g., ‘file change detection unit’, ‘storage-detection unit’, and a ‘cloud federation detection unit’) to detect a change in the memory unit 130 may be further included in the control unit 110. Further, the operation of detecting a change in the memory unit 130 may be realized as an operation of the cloud federation unit 112.

A federation information output control unit 114 may control cloud federation information regarding all or some of files stored in the memory unit 120 to be output through an output unit of the input-output unit 120. The cloud federation information may include information (e.g., federation indicating information) indicating whether a file corresponding to a file stored in the memory unit 130 is stored in the cloud server 300. For example, the federation information output control unit 114 may control federation information indicating that a file is stored in one and more cloud storage servers 300 when the file is determined to be stored in one or more cloud storage servers 300. Further, if a file is not stored in the cloud storage server 300, the federation information output control unit 114 may not provide cloud federation information regarding the file or may provide non-federation information in an effort to indicate that the file is not stored in the cloud storage server 300.

Accordingly, the output cloud federation information, for example, the federation indicating information, may allow a user to be informed of whether the file is stored in the cloud storage servers 300. In addition, the user may be able to utilize the cloud federation information when managing the file. For example, if a user wishes to delete some of the files stored in the memory unit 130 because of a lack of a memory capacity or other reasons, the user may check the output cloud federation information to confirm whether a corresponding file is stored in the cloud storage server 300. According to aspects of the invention, the user may be able to delete a file stored in the memory unit 130 if there is a corresponding file stored in the cloud storage server 300. Accordingly, a corresponding file remains the cloud storage server 300 although the file is deleted in the memory unit 130 of the mobile device 100. Accordingly, it may be possible to reduce a likelihood of the file from being deleted completely to the point where the file cannot be recovered. In addition, before deleting the file, the user may skip accessing the cloud storage server to confirm whether the file to be deleted is stored in the cloud storage server 300.

According to exemplary embodiments of the present invention, the cloud federation information, which may be output under the control of the federation information output control unit 114, may further include storage type information indicating a storage type of the file stored in the cloud storage server 300. Using the storage type information, a user may be able to be informed of whether a corresponding file of the file to be locally deleted is synchronized with or backed-up to the cloud storage server 300. If a file to be deleted is determined to be synchronized with the cloud storage server 300 and the user does not wish to delete the file completely, the user may change a storage type of the file into a backup type through the cloud federation unit 112. There may be no specific limitation for changing a storage type of a file, but the storage type may be changed concurrently with or before deleting the file from the memory unit 130. If a file synchronized with the cloud storage server 300 is deleted in the memory unit 130, a corresponding file, which may be a synchronization type, may be deleted from the cloud storage server upon synchronization. Thus, if a storage type of a file is changed into backup concurrently with or before deleting the file, it may be possible to reduce a likelihood of the file from being deleted in the cloud storage server 130.

According to an exemplary embodiment of the present invention, if a user wishes to delete a file in the memory unit 130, a query may be output on a predetermined User Interface (UI) to confirm whether the user wishes to change a storage type into a backup type. The operation for outputting of the query may be controlled by the federation information output control unit 114. However, aspects of the invention are not limited thereto, such that outputting of the query may be controlled by a different unit. For example, the operation for outputting of the query may be realized as an operation of the control unit 110, which may be configured to control an output unit. If the query is output to confirm whether the user wishes to change a storage type of a file stored in the cloud storage server 300, the cloud federation unit 112 may change the storage type of the file into a backup type when a confirmation or selection is received from a user. Accordingly, it may be possible to change a storage type of a selected file from a synchronization type into a backup type before locally deleting the corresponding file.

According to an exemplary embodiment of the present invention, there is no specific limitation on the way that the cloud federation information may be output. For example, the cloud federation information may be output visually, such as a text and an icon. In another example, the cloud federation information may be output aurally by utilizing a predetermined sound (e.g., acoustics). Hereinafter, an example in which cloud federation information is output as an icon is described, however, aspects of the invention are not limited thereto, such that the cloud federation information is able to be output as a different type of visual image or as an audio sound.

According to an exemplary embodiment of the present invention, the federation information output control unit 114 may control cloud federation information regarding a file stored in the memory unit 130 to be output via an output unit of the input-output unit 120 of the mobile device 100 when the file is executed. For example, if an image file, a video file or a document file stored in the memory unit 130 is executed, the federation information output control unit 114 may control cloud federation information regarding a corresponding file to be output on a display in which the corresponding file may be executed. In another example, if an audio file stored in the memory unit 130 is executed, the federation information output control unit 114 may control cloud federation information regarding the audio file to be output through a speaker in a manner of overlapping a sound which may already be output before the execution of the audio file.

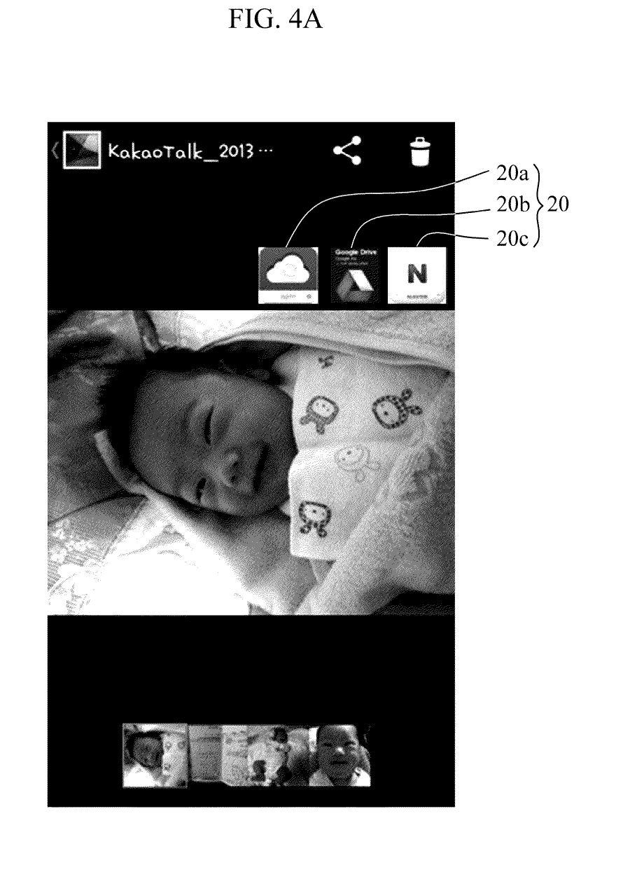

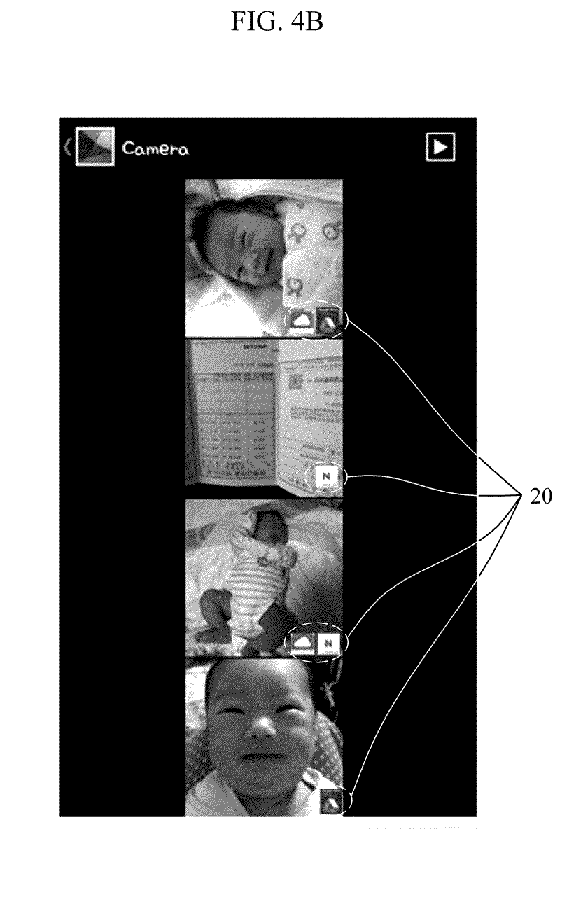

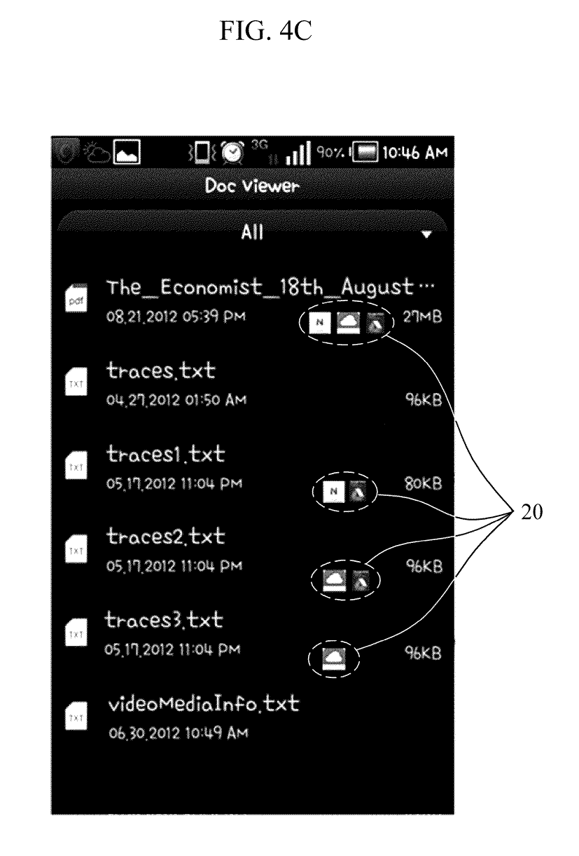

FIG. 4A is a diagram illustrating cloud federation information along with a corresponding file after the corresponding file is executed according to an exemplary embodiment of the present invention.

Referring to FIG. 4A, if an image file stored in a folder named ‘KakaoTalk_{—}2013 . . . ’ of the memory unit 130 is executed by a predetermined image viewing application, cloud federation information 20 regarding the image file is output on the right upper side, and above, of a corresponding image; however, aspects are not limited thereto such that the cloud federation information 20 may be displayed at other portions in relation to the corresponding image, such as, below and/or on the left side. In FIG. 4A, the cloud federation information 20 includes three icons, a first icon 20a, a second icon 20b and a third icon 20c, indicating that the image file is synchronized with three different cloud storage servers, a first cloud storage server, a second cloud storage server, and a third cloud storage server, respectively.

In another example, a federation information output control unit 114 may control cloud information regarding or associated with an item or file, which may be included in a list to of files stored in the memory unit, to be displayed along with the corresponding item or file. For example, if a list of a plurality of image files, video files or document files stored in the memory unit 130 is displayed, the federation information display unit 114 may control cloud federation information regarding each item or file, which may be included in the displayed list of files, to be displayed along with a corresponding item or file. At this time, the list of files is not limited to be displayed as texts, and may be displayed as predetermined icons or small-sized preview images, such as thumbnail images.

In exemplary embodiments of the present invention, there is no specific limitation of a trigger that may initiate a list of files to be displayed through an output unit of the input-output unit 120 of the mobile device. For example, if a list of files stored in a specific folder of the memory unit 130 is displayed by executing a file management program (e.g., an application to manage a file) installed in the mobile device 100, cloud federation information regarding one or more items or files included in the list of files may be displayed together. Further, if a list of files stored in a specific folder of the memory unit 130 of the mobile device 100 is displayed by executing an application program installed in the mobile device 100, such as an application to execute a file, cloud federation information regarding one or more items included in the list of files may be displayed together.

FIG. 4B and FIG. 4C are diagrams illustrating cloud federation information regarding each item included in a file list along with the file list according to exemplary embodiments of the present invention.

Referring to FIG. 4B, when a preview list of image files stored in a folder named ‘Camera’ is displayed, cloud federation information 20 regarding each image file included in the preview list is displayed on the preview list. In FIG. 4B, every displayed image file is synchronized with one or more cloud storage servers 300. In addition, referring to FIG. 4C, if a text list of file names stored in a specific folder is displayed by executing an application named ‘Doc Viewer’, cloud federation information regarding each text file included in the list is displayed on the list. In FIG. 4C, the second text file (i.e., ‘traces.txt’) and the sixth text file (i.e., ‘videoMediaInfo.txt’) from among a list of six text files are not synchronized with any cloud storage server 300, but other files are synchronized with one or more cloud storage servers 300.

The federation information output control unit 114 may control cloud federation information to be displayed by displaying files or a list of files, which may be synchronized with one or more cloud storage servers. For example, if a user selects a specific cloud or a cloud storage server, the federation information output control unit 114 may control a list of files, which may be synchronized with the selected cloud, to be displayed. Further, in addition to information regarding the selected cloud, file identification information (e.g., a file name) included in the displayed file list may be used as cloud federation information.

In another exemplary embodiment, the federation information output control unit 114 may not output cloud federation information regarding a corresponding file when the corresponding file is executed or a list of files are executed, and instead may control the cloud federation information to be displayed when a predetermined command is received from a user. However, aspects of the invention are not limited thereto, such that the cloud federation information may be displayed when a request to retrieve the respective file is received. The file may be retrieved for execution, for identification, for displaying the file and/or associated file information, and the like.

For example, when a request is received from a user to delete a specific file stored in the memory unit 130, the federation information output control unit 114 may control cloud federation information regarding the file to be displayed via an output unit of the input-output unit 120 of the mobile device 100. Further, a signal indicating that the request to delete the specific file received from the user may be transmitted from a file management unit 116 to the federation information output control unit 114. However, aspects of the invention are not limited thereto, such that different units may be used in the transmission.

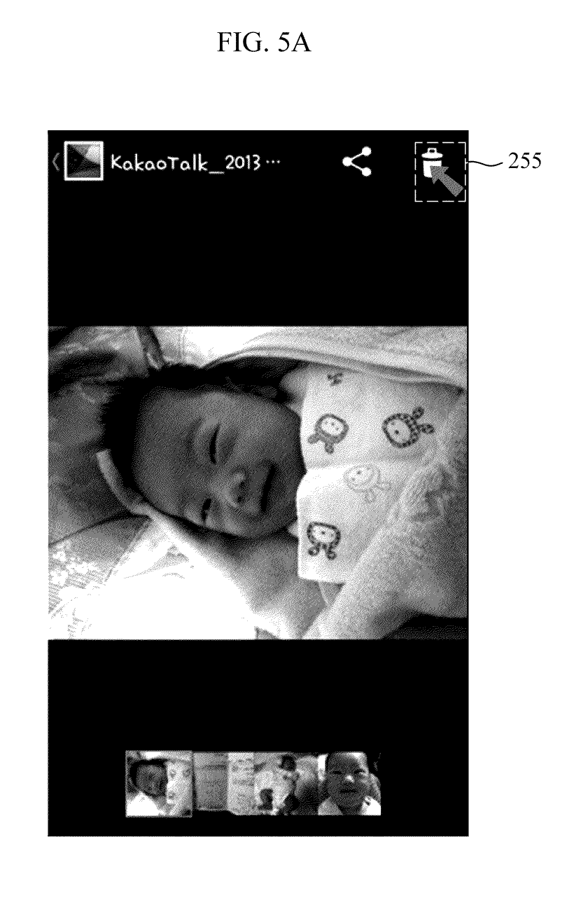

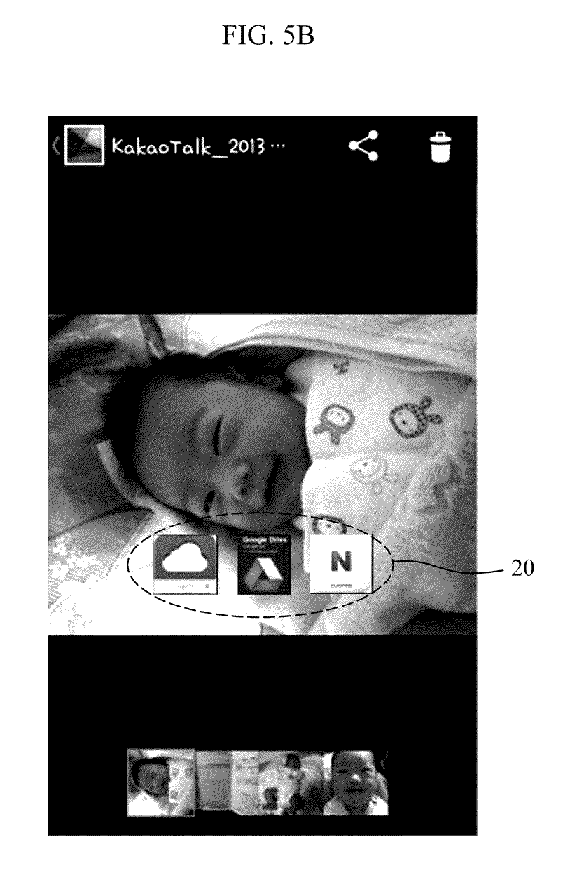

FIG. 5A and FIG. 5B are diagrams illustrating a screen displayed after a request to delete a specific file is received according to exemplary embodiments of the present invention.

Referring to FIG. 5A, when an image file stored in a folder named ‘KakooTalk_{—}2013 . . . ’ of the memory unit 130 is executed and displayed, a request to delete the image file is received from a user using a trash bin icon 255 located on the upper right side on a display. The file displayed in FIG. 5A may be the same as that of FIG. 4A, but cloud federation information regarding the file is not displayed in FIG. 5A. In addition, referring to FIG. 5B, if a request to delete a displayed file is received, the federation information output control unit 114 displays cloud federation information 20 regarding the file in a pop-up window. However, aspects of the invention are not limited to the location and the display method of the cloud federation information 20 shown in FIG. 5B.

Further, the cloud federation information output control unit 114 may control cloud federation information to be displayed along with an executed file (see FIG. 4A), to be displayed on a list of files (see FIG. 4B and FIG. 4C), or to be displayed again even after a request to delete a file is received from a user.

According to aspects of the invention, the federation information output control unit 114 may control to output cloud federation information regarding one or more files, which may be requested to be deleted. Further, when a file requested to be deleted is stored in the cloud storage server 300, the federation information output control unit 114 may control to output cloud federation information (e.g., non-federation information) regarding the file. Accordingly, a user may be able to more quickly delete a file when the file is stored in the cloud storage server 300. If the file is not stored in the cloud storage server 300, a user may be prompted to determine again whether to delete the file after confirming that that the filing is not stored in the cloud storage server 300.

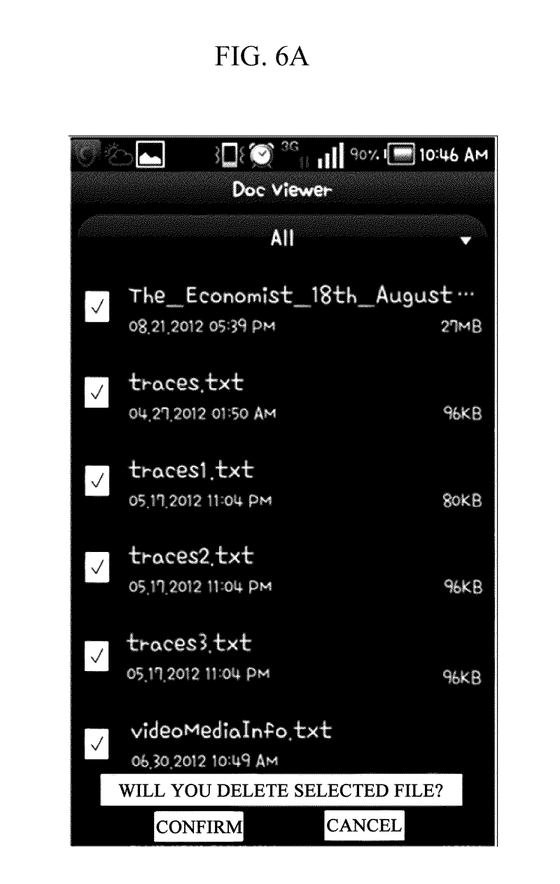

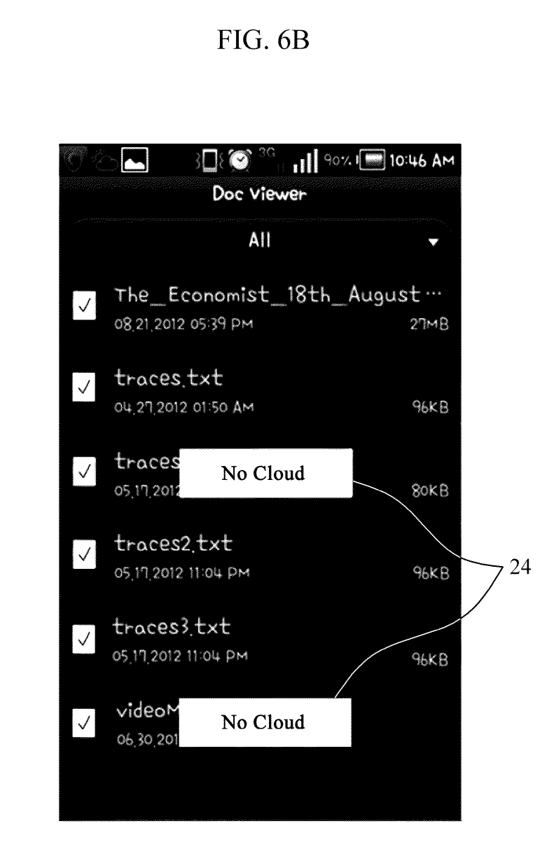

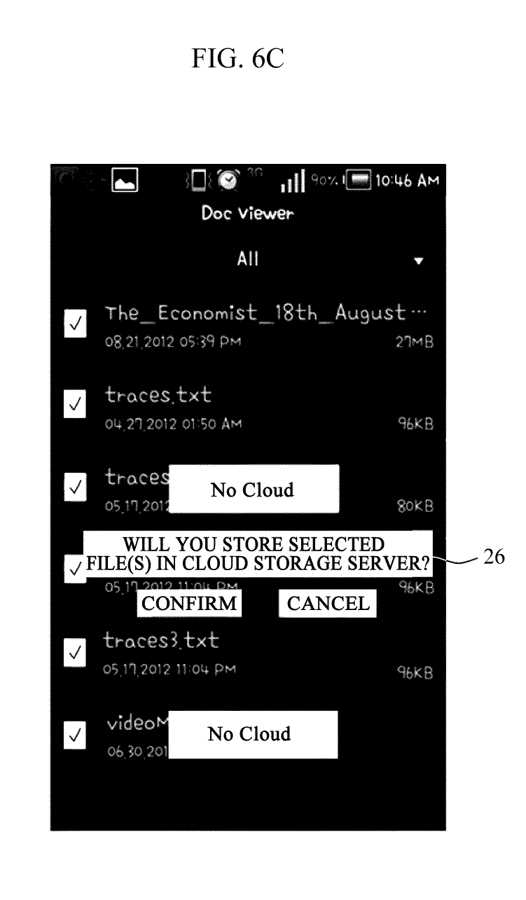

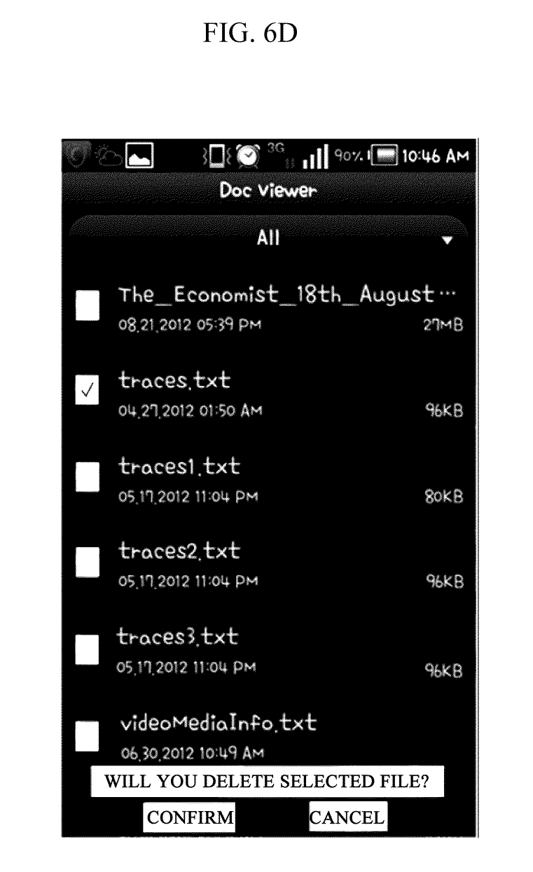

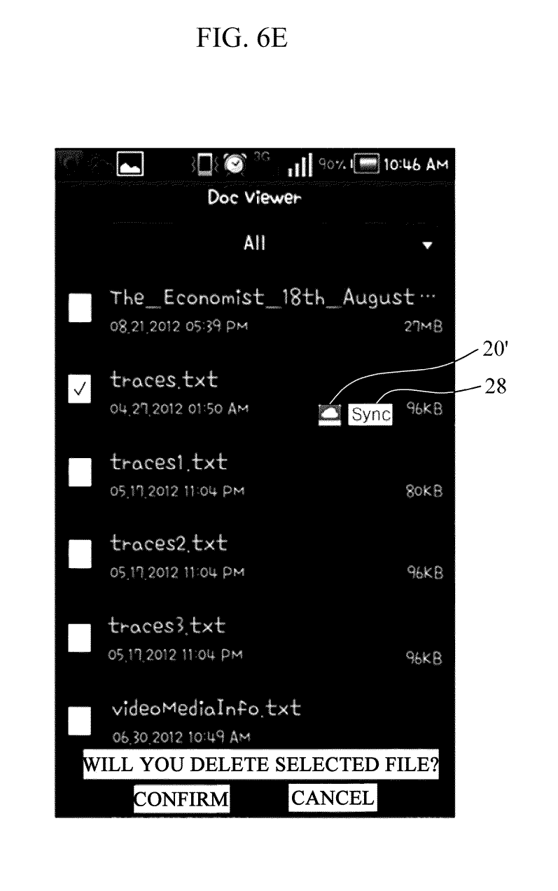

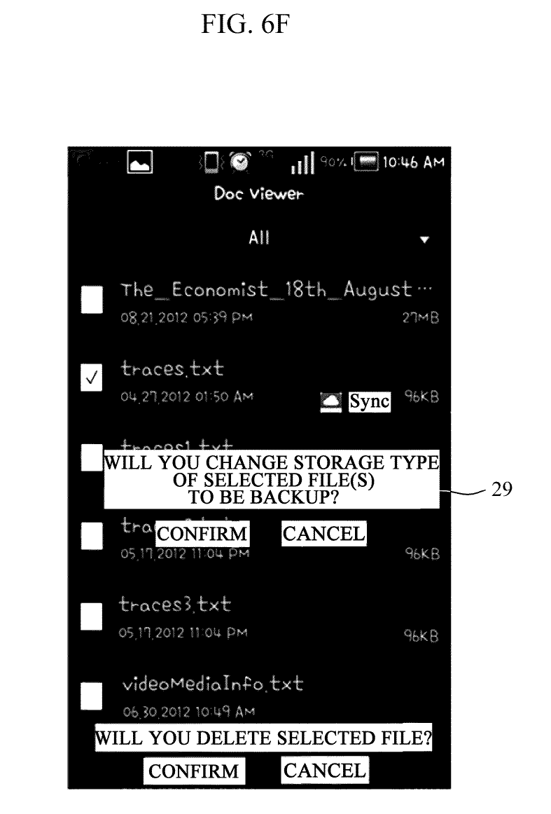

FIG. 6A is a diagram illustrating a request to delete all the files included in a list of files displayed in FIG. 4C according to an exemplary embodiment of the present invention.

Different from FIG. 4C, FIG. 6A does not show cloud federation information regarding the files included in the list of files. In addition, FIG. 6B is a diagram illustrating a screen which is displayed after receiving the request to delete all the files shown in FIG. 6A according to exemplary embodiments of the present invention.

Referring to FIG. 6B, non-federation information 24 may be displayed regarding some of files, more specifically, the third file (i.e., ‘traces1.txt’) and the sixth file (i.e., videoMediaInfo.txt), which may not be stored in any cloud storage server 300, out of all the files included in the file list shown in FIG. 6A. However, aspects of the invention are not limited to a “No Cloud” illustrated in FIG. 6B as an indication of lack of storage in a cloud server and may include various icons, images, text, sound and other indicators to illustrate a lack of storage in a cloud server.

FIG. 6C is a diagram illustrating a screen which is displayed after receiving the request to delete all the files shown in FIG. 6A according to exemplary embodiments of the present invention.

When cloud federation information regarding a file is to be output is displayed in response to a request to delete the file, a query may be output on a predetermined UI to confirm whether the user wishes to store the file in the cloud storage server 300, with or without the cloud federation information. Referring to FIG. 6C, a query 26 reciting, “Will you store a selected file(s) in a cloud storage server?” is displayed. However, language or display of query is not limited thereto, such that different language, image, animation, and the like may be displayed. Further, the operation for outputting a query may be realized as an operation of the control unit 110, which may control an output unit.

As such, if a query is output to confirm whether a user wishes to store a file requested to be deleted locally in a cloud server 300, the cloud federation unit 112 may generate and store a copy of the file to be deleted in the cloud storage server 300 when a confirmation is received from the user. However, aspects of the invention are not limited thereto, such that a corresponding file or a copy of the file may be automatically uploaded or stored in a cloud storage server 300 when a file is requested to be deleted locally. Such automated storage may be based on a condition, which may include, without limitation, at least one of a file type, a file creation date, a file modification date, frequency of use, and the like. Further, the cloud federation unit 112 may transfer the local file to the cloud storage server 300 in response to the request for deletion. In addition, the file management unit 116 may delete the local file when a corresponding file or a copy of the file to be locally deleted gets uploaded or stored in the cloud storage server 300. Accordingly, if a file is indicated by a user as not being stored in the cloud storage server 300, a copy of the file to be deleted may be generated and stored automatically in the cloud storage server 300 before being locally deleted.

According to aspects of the invention, with or without the above-described query, a UI may be displayed, allowing a user to select one of a plurality of cloud storage servers 300, which may interwork or have a network connection with the mobile device 100. Further, the cloud federation unit 112 may control a file, which is requested to be deleted, to be stored in one or more cloud storage servers selected by the user from among a plurality of cloud storage servers 300. However, aspects of the invention are not limited thereto. For example, the cloud federation unit 112 may store a file requested to be deleted in one or more cloud storage servers, which may be selected from among a plurality of cloud storage servers 300 according to a predetermined standard. The predetermined standard may be set by a user, an application, an operating system, the file itself, and the like. In another example, the cloud federation unit 112 may store a file requested to be deleted in an arbitrary cloud storage server 300 selected in consideration of a network state or a remaining memory capacity.

According to an exemplary embodiment of the present invention, the federation information output control unit 114 may output cloud federation information containing a storage type of a file requested to be deleted, when the file is stored in the cloud storage server 300. FIG. 6D and FIG. 6E are diagrams for explaining illustrating a request to delete the second file on the file list shown in FIG. 4C according to exemplary embodiments of the present invention. In addition, FIG. 6F is a diagram illustrating a screen which is displayed after receiving the request to delete some of the files shown in FIG. 6D according to an exemplary embodiment of the present invention.

Referring to FIG. 6E, a storage type 28 of a file requested to be deleted is displayed along with an image 20′ of a cloud storage server 300 in which the file is stored. Although a button with “sync” language is shown in FIG. 6E as a storage type, aspects of the invention are not limited thereto such that other storage types may be included.

Further, if the file requested to be deleted is synchronized in the corresponding cloud storage server 300, the federation information output control unit 114 may control a query on a specific UI to confirm whether the user wishes to change a storage type of the file into a backup type.

Referring to FIG. 6F, a query 29 reciting “Will you change storage type of a selected file(s) into backup?” is displayed. However, according to aspects of the invention, the manner of display and the specific language of the query are not limited to query 29. The operation for outputting of a query may be realized as an operation of the control unit 110, rather than the federation information output control unit 114, as described above.

If the query of whether a user wishes to change a storage type of the file into a backup type is output, the cloud federation unit 112 may perform an operation to change the storage type of the file into the backup type when a confirmation regarding the query is received from the user. In addition, the file management unit 116 may perform an operation to delete the file after the storage type of the file is changed into the backup type. Accordingly, if a file, which may be set to be synchronized with the cloud storage server 300, is selected to be deleted by a user, a storage type of the file may be changed into the backup type and then the file may be backed-up to the cloud storage server 300 before deleting the file.

As described above, the federation information output control unit 114 may control cloud federation information regarding one or more files to be output. More specifically, the federation information output control unit 114 may obtain cloud federation information regarding one or more displayed files or one or more files included in a displayed list of files. In exemplary embodiments of the present invention, the federation information output control unit 114 may obtain cloud federation information in various ways.

For example, the federation information output control unit 114 may obtain cloud federation information regarding one or more files stored in the memory unit 130 from an additional database, which may store data about interworking between the mobile device 100 and the cloud storage server 300. The data may include, without limitation, the cloud federation file database 132 included in the memory unit 130 in FIG. 2. Accordingly, when a specific file is executed to be displayed or a list of files is displayed, the federation information output control unit 114 may obtain cloud federation information regarding one or more displayed files with reference to the cloud federation file database 132.

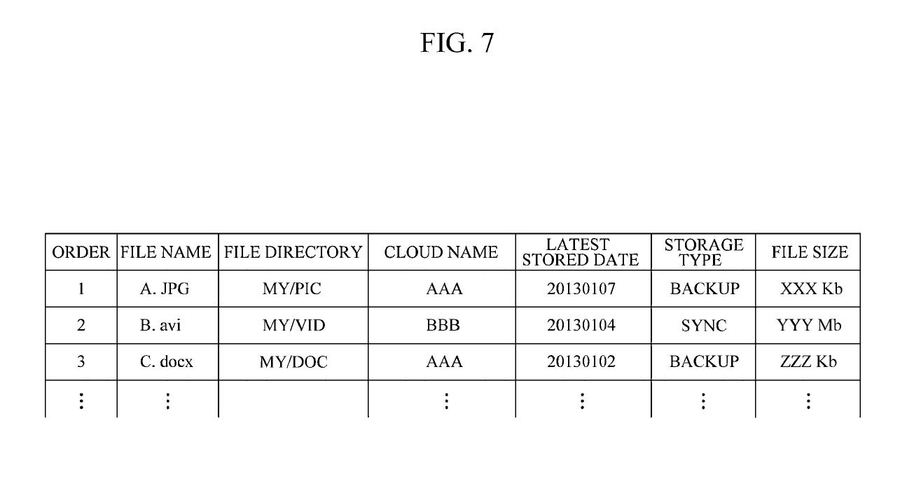

FIG. 7 is a diagram illustrating a format of a cloud federation file database according to an exemplary embodiment of the present invention.

Referring to FIG. 7, the cloud federation file database 132 includes at least one of order information, a file name, a file directory, a cloud name, latest stored date, a storage type and a file size. However, aspects of the invention are not limited thereto, such that the cloud federation file database may include additional information, different information, or less information. The file name (e.g., A.JPG, B.avi, C.docx) may be used to identify a corresponding file. The file directory may indicate a location or directory on which the corresponding file is stored. The cloud name (e.g., AAA and BBB) may be used to identify a cloud in which the corresponding file is stored. In addition, one or more cloud names may be provided and address of the cloud storage server may be provided in addition or in lieu of the cloud storage server name. The latest stored date is the latest date on which the corresponding file is stored in the cloud, and may include a stored point in time as well as a stored date. The storage type may indicate whether the corresponding file is synchronized with or backed-up to the cloud. In addition to the file size, additional information regarding the corresponding file may be further included in the cloud federation file database 132.

According to exemplary embodiments of the present invention, there is no specific limitation on a subject and a method for generating the cloud federation file database 132. For example, the file management unit 116 may generate cloud federation file database 132 and store the generated cloud federation file database 132 in the memory unit 130. In addition, in order to generate or change the cloud federation file database 132, the file management unit 116 may use information received from the cloud federation unit 112 or data (e.g., data indicated by the reference number 10 in FIG. 3) transmitted and/or received between the cloud federation unit 112 and one or more of the cloud storage servers 300. Further, an application executing a file or an application displaying a list of files may store database identical or similar to the cloud federation file database 132. The federation information output control unit 114 may control the cloud federation information to be output using a database stored in a corresponding application.

The federation information output control unit 114 may obtain cloud federation information from one or more files. For example, one or more files may include cloud federation information as a piece of attribute information. Further, the federation information output control unit 114 may control cloud federation information to be output with reference to attribute information regarding a file. One or more units in the mobile device 100, for example, the file management unit 116, may include the federation information in the attribute information.

The file management unit 116 may manage files stored in the memory unit 130. For example, if a new file is generated by a different unit in the mobile device 100, for example, an application, or if a new file is received through the communication unit 140, the file management unit 116 may store the new file in the memory unit 130. In addition, if there is a predetermined request (e.g., fetching, deleting, changing a file, and the like) regarding a file stored in the memory unit 130, the file management unit 116 may perform an operation (e.g., fetching, deleting, or changing (deleting and then re-storing) a file) to process the corresponding request.

In addition, the file management unit 116 may notify the cloud federation unit 112 of a change occurring in a file stored in the memory 130 (e.g., storing a new file and modifying or deleting a previously stored file), so that any file stored in the storage unit 130 may be stored in the cloud storage server 300, as described above. According to an exemplary embodiment of the present invention, the file management unit 116 may generate or modify the cloud federation file database 132.

If a request to delete a file stored in the memory unit 130 is received, the file management unit 116 may adaptively perform an operation to delete the file according to whether the file is stored in the cloud storage server 300. Here, adaptively performing an operation to delete the file may include, without limitation, performing a different operation to delete the file in different ways according to whether the file is stored in the cloud storage server 300.

The file management unit 116 may further determine whether a copy of the file requested to be deleted is stored in the cloud storage server 300, and if the respective file or copy is determined to be stored in the cloud storage server 300, the file management unit 116 may determine whether the file is synchronized with or backed-up to the cloud storage server 300. The above-described determining operations may be performed using the cloud federation file database 132 stored in the memory unit 130 or using attribute information that may be included in the file. If it is determined that a copy of the file requested to be deleted is not stored in the cloud storage server 300, the file management unit 116 may, prior to deleting the file, request the cloud federation unit 112 that the copy of the file be generated and stored in the cloud storage server 300. The operation for storing and then deleting a file may be automatically performed by an algorithm embedded in the file management unit 116 or may be performed in response to a request from a user. For the latter case, a result of determination on whether the file requested to be deleted is stored in the cloud storage server 300 may be output through an output unit of the input-output unit 120. When a request to store a copy the file to be deleted in the cloud storage server 300 is received from the user, the copy of the file may be stored in the cloud storage server 300 and then the local copy may be deleted. Further, if a request to store the file in the cloud storage server 300 is not received from the user or if a response indicating that the user does not wish to store the file in the cloud storage server 300 is received, the file may be locally deleted without storing a copy in the cloud storage server 300.

If it is determined that a copy of the file requested to be deleted is stored in the cloud storage server 300, the file management unit 116 may locally delete the file without generating a copy of the file for storing in the cloud storage server 300. According to an exemplary embodiment of the present invention, the file management unit 116 may adaptively delete the file requested to be deleted according to a storage type of the file. For example, if a copy of the file requested to be deleted is stored in the cloud storage server 300, the file management unit 116 may locally delete the file without additional operation. On the other hand, if a copy of the file requested to be deleted is not stored in the cloud storage server 300, the file management unit 116 may request the cloud federation unit 112 to change a storage type of the file to a backup type. In response, a copy of the file to be deleted may be generated and stored in the cloud storage server 300.

The operation for changing a storage type of a file may be performed before the file management unit 116 deletes the file, but aspects of the invention are not limited thereto. In addition, the operation for changing a storage type of a file requested to be deleted may be automatically performed by an algorithm embedded in the file management unit 116 or may be performed in response to a request from a user. For the latter case, a result of determination on whether to change a storage type of a file requested to be deleted may be output through an output unit of the input-output unit 120. In addition, when a request to change the storage type of the file is received from the user in response to the result of the determination, the storage type of the file may be changed. Further, if a request to change the storage type of the file is not received from the user or if a response indicating that the user does not wish to change the storage type of the file is received, the storage type of the file may be changed.

The above-described operations of the file management unit 116 may be performed regardless of whether the cloud federation information is output by the federation information output control unit 114. In addition, when the mobile device 100 does not include the federation information output control unit 114, and/or cloud federation information is not displayed, the above-described adaptive operations of the file management unit 116 may be more useful and more efficient in reducing a likelihood of a specific file from being completely deleted. However, aspects of the present invention are not limited thereto. For example, the mobile device 100 may include the federation information output control unit 114, which may control cloud federation information to be displayed along with an executed file or a list of files.

The cloud federation determination unit 118 may determine whether a copy of the file stored in the memory unit 130 is stored in the cloud storage server 300. There is no specific limitation on information or documents, which may be utilized by the cloud federation determination unit 118, when determining whether a copy of a local file is stored in the cloud storage server 300. For example, the cloud federation determination unit 118 may utilize the cloud federation file database 132 included in the memory unit 130 or attribute information regarding one or more files. However, aspects of the present invention are not limited thereto.

The cloud federation determination unit 118 may be an additional unit, which may be independent of the file management unit 116, or may be a subunit of the file management unit 116. For example, in FIG. 2, the cloud federation determination unit 118 may be illustrated as being independent of the file management unit 116, however, aspects of the invention are not limited thereto. For example, the cloud federation determination unit 118 may be a subunit (e.g., as indicated in a dotted-line box in FIG. 2) included in the file management unit 116.

The federation information output control unit 114 may receive a result of the determination from the cloud federation determination unit 118 before outputting cloud federation information, and control the cloud federation information based on the result of the determination. In addition, the file management unit 116 may perform file management based on the result of the determination received from the cloud federation determination unit 118. More specifically, the file management unit 116 may be able to perform file management by receiving a result of determination from the cloud federation determination unit 118 without determining whether a file requested to be deleted is stored in the cloud storage server. Further, the file management unit 116 may determine whether a file requested to be executed, which may be requested to be displayed, or a file requested to be deleted is stored in the cloud storage server 300.

Based on a result of determination in the cloud federation determination unit 118 of whether a copy of the file requested to be deleted is stored in the cloud storage server 300, the file management unit 116 may adaptively delete the local file. Further, the cloud federation determination unit 118 may determine whether a copy of the file requested to be deleted or a copy of one or more files stored in the memory unit 130 are stored in the cloud storage server 300.

Referring to FIG. 1 and FIG. 2, the input-output unit 120 may provide a UI of the mobile device 100, and may include an input module and an output module. The input module may be used to input at least one of user data, an input signal, a command and a request signal to the mobile device 100. The output module may be used to output at least one of data, information and a signal, which may be processed in the mobile device 100. In more detail, the input module may include, without limitation, a keypad, a dome switch, a button, a jog wheel and a touchpad by which data and command may be received from a user, as well as a microphone by which a voice and a sound may be received from the user. In addition, the output module may include, without limitation, a display, by which an image signal and a video signal may be output, and a speaker, by which an audio signal may be output. The output module may further include an audio output device, such as an ear jack and a vibration module, by which a mechanical signal (e.g., vibration) may be output.

In addition, the mobile device 100 may include a touch screen as the input-output unit 120. The touch screen is an exemplary UI, which may allow interaction between a user and the mobile device 100. The touch screen may perform an operation both as a touch panel of the input module and as a display of the output module. The touch screen may be a dual layer type in which the touch panel and the display may be combined in layer order, or may be a single layer type in which the touch panel and the display may be combined as one. A user may input a command or information to the mobile device 100 by touching the touch screen using a finger or a stylus pen. In addition, the mobile device 100 may output a text, an image and/or a video through the touch screen.

The memory unit 130 may store applications and data that may be used to manage and operate the mobile device 100. In more detail, the memory unit 130 may store various application programs, such as an Operating System (OS) program, a plurality of module programs and applications, which may be used by the control unit 110 to process and control data. In addition, the memory unit 130 may store various data and information, such as an email, a text, an image, a video, a document, a music file, a phone number, a phone call history and an instant message. The memory unit 130 may include, without limitation, Random Access Memory (RAM), embedded memory, external flash memory, such as Universal Subscriber Identity Module (USIM), floppy disk memory, and Read Only Memory (ROM).

In addition, the memory unit 130 may store a program for the mobile device 100 to output cloud federation information and manage a file stored in the memory unit 130. Furthermore, the memory unit may include the cloud federation information database 132 to store cloud federation information regarding some or all files stored in the memory unit 130. Since already described above with reference to FIG. 7, an example of a format of the cloud federation information database 132 will not be described hereinafter.

The communication unit 140 may be used to communicate with a wired/wireless communication network and/or a different electronic device by transmitting and receiving an electromagnetic signal. The communication unit 140 may be able to perform communication using one or more wireless communication protocols, and there may be no limitation on the types and the number of wireless communication protocols that may be used. For example, the communication unit 140 may include a mobile communication unit, which may enable a voice, video or data communication according to a mobile communication standard, and a WiFi communication unit, which may enable Wireless Local Area Network (WLAN) communication. The mobile device 100 may be able to manage files stored in the memory unit 130 by communicating with the cloud storage server 300 via the communication unit 140, as described above.

The sensor unit 150 may include, without limitation, a gravity sensor, a proximity sensor, a motion sensor and an illumination sensor. In addition, the camera unit 160 may be used to obtain an image and/or video signal. A file obtained through the sensor unit 150 and/or the camera unit 160 may be stored in the memory unit 130 through the file management unit 116. In addition, the mobile device 100 includes a power supply unit (not illustrated). The power supply unit may be used to supply each of configurations of the mobile device 100 with power used to operate the mobile device 100. The mobile device 100 may include a detachable or embedded battery as a power source. However, aspects of the invention are not limited thereto, such that the mobile device 100 may further include an additional module to receive power from an external power system.

Hereinafter, a file management method of a mobile device according to an exemplary embodiment of the present invention is provided.

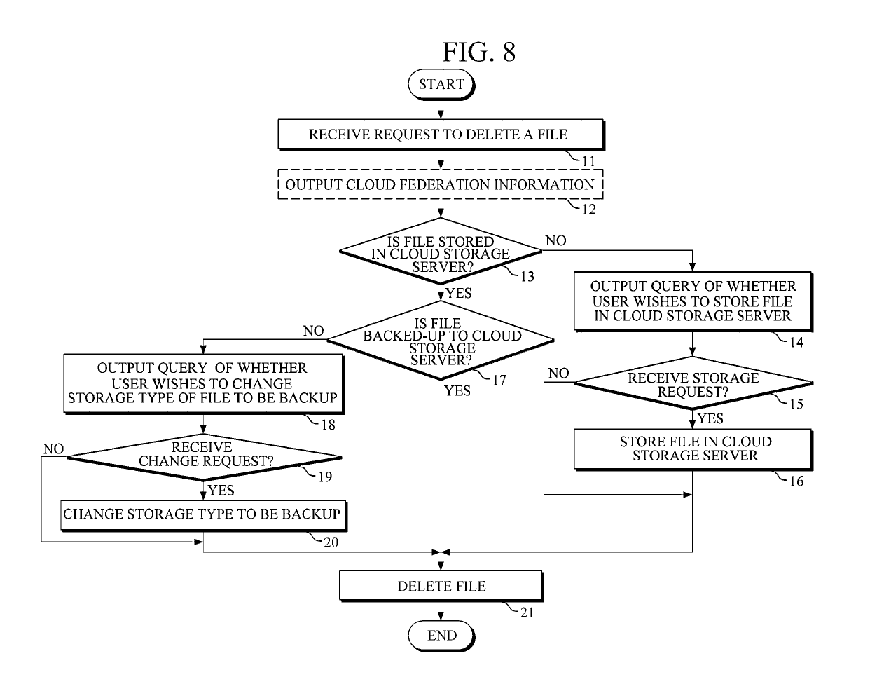

FIG. 8 is a flow chart illustrating a file management method of a mobile device according to an exemplary embodiment of the present invention. The methods of FIG. 8 below will be described as if performed by the mobile device of FIG. 2, but are not limited as such.

The file management method shown in FIG. 8 is a file management procedure when there is a request to delete one or more files stored in the mobile device. The request to delete a file may be generated without specific limitation. Thus, the request to delete a file may be generated in response to a request from a user or the request to delete a file may be generated before, during or after executing a specific application. Such a request to delete a file may include a request to remove the file, a request to modify a previously stored file, and a request to update a file.

File management method of FIG. 8 may be described with respect to the mobile device 100 of FIG. 1 and FIG. 2, however, aspects of the invention are not limited thereto. Further, the file management method will be provided briefly in following, and any description omitted hereinafter may be the same as that of the file management operations described with reference to FIG. 1, FIG. 2, FIG. 3, FIG. 4, FIG. 5, FIG. 6, and FIG. 7.

Referring to FIG. 1, FIG. 2 and FIG. 8, the mobile device 100 receives a request to delete a file in operation 11. In operation 11, a file management unit 116 of the mobile device 100 may receive the request to delete a file from the mobile device 100 or a local file. The request to delete a file or local file may be generated without specific limitation. Accordingly, the request to delete a file or local file may be a request received from a user or a request which may be generated during execution of a specific application.

If receiving the request to delete a local file, the federation information display unit 114 may, if applicable, display cloud federation information regarding the file requested to be deleted in operation 12. Operation 12 is drawn with a dotted line in FIG. 8, to indicate that operation 12 is an operation that may or may not be applicable or optional. In addition, according to an exemplary embodiment of the present invention, prior to operation 11, cloud federation information regarding an executed file or a file included in a displayed list may be displayed by the federation information display unit 114.

If receiving the request to delete the local file in operation 11, the mobile device 100, more specifically, a file management unit 116, may determine whether a copy of the file requested to be deleted, or a server file, is stored in the cloud storage server 300 in operation 13. In operation 13, a cloud-synchronized-file database 132 stored in the memory unit 130 or attribute information regarding the file may be utilized, as described above. Based on the determination of operation 13, the server file may be configured differently to be stored in the cloud storage server 300. For example, a copy of the local file may be configured to be generated and stored as a server file if the server file is not already stored in the cloud storage server 300, or the local file may be configured to be transferred to the cloud storage server 300 to be stored as a server file. Further, the server file may be configured, such that a storage type of the server file is modified for retaining the server file if the server file is determined to be stored in the cloud storage server 300.

If it is determined that a copy of the file requested to be deleted, or a server file, is not stored in the cloud storage server 300, a query of whether the user wishes to store the file, or its copy, in the cloud storage server 300 is displayed through an output unit of the input-output unit 120 in operation 14. In operation 14, cloud federation information regarding the file may be displayed via the output unit along with the query. In addition, details about the query to be output in operation 14 may not be limited to a specific configuration. In addition, there may be no limitation on a subject which may be output by the query. For example, outputting of the query may be performed by the control unit 110 or the federation information output control unit 114.

A confirmation received from a user in response to the query, which is output in operation 14, may be checked. In more detail, an input or confirmation from a user in response to a question of whether the user wishes to store the file, or its copy, in the cloud storage server 300 may be checked in operation 15. According to a result of operation 15, it may be determined either to store a copy of the file in the cloud storage server 300 in operation 16 and then delete the local file in operation 21 or to delete the local file without storing a copy of the file in the cloud storage server 300.

If it is determined in operation 13 that a copy of the file requested to be deleted is stored in the cloud storage server 300, a storage type of the file stored in the cloud storage server 300 is checked to be determined in operation 17. In more detail, operation 17 is a process to determine whether the local file is synchronized with the corresponding file in the cloud storage server 300 or a copy of the local file is backed-up to the cloud storage server 300. If it is determined in operation 17 that a copy of the local file is backed-up to the cloud storage server 300, the local file is deleted in operation 21.

If it is found in operation 17 that the file requested to be deleted is synchronized with a corresponding file in the cloud memory unit 300, a query of whether the user wishes to change a storage type of the server file to a backup type is displayed through an output unit of the input-output unit 120 in operation 18. In operation 18, cloud federation information regarding the file to be deleted may be displayed together with the query. In addition, details about the query to be output in operation 18 are not limited to be specific. For example, the operation for outputting of the query may be realized as an operation the control unit 110 or an operation of the federation information output control unit 114.

In operation 19, a determination of the response received from the user regarding the query output in operation 18 is checked. In more detail, an input or response received from the user regarding a question of whether the user wishes to change a storage type of the server file into the backup type is checked in operation 19. According to a result in operation 19, a storage type of the server file may be changed to the backup type in operation 20 and the local file is deleted in operation 21, or the local file may be deleted without changing a storage type of the server file in operation 21. More specifically, if the user chooses to change the storage type of the server file in operation 19, then the server file is changed to the backup type in operation 20 and local file is deleted in operation 21. If the user chooses not to change the storage type of the server file in operation 19, the local file is deleted without changing the storage type of the server file and without backing up the local file in operation 21.

According to aspects of the invention, the file management method may be performed without operation 11 for receiving a request to delete a local file. For example, the file management method may proceed when a file stored in a memory unit of a mobile device is requested to be executed or a list of files is requested to be displayed. Further, operation 11 of receiving the request to delete a local file may be replaced by receiving a request to execute or display a local file. In addition, among operations following operation 12, only operations corresponding to the file management method may be selectively performed.

For example, if a request to execute a file or a request to display a file list is received, a determination of whether the file requested to be executed or a file included in the list requested to be displayed is synchronized with a cloud storage server may be made. Such a process may be performed by a file management unit (e.g., file management unit 116 in FIG. 2) or a cloud federation determination unit (e.g., cloud federation determination unit 118 in FIG. 2), as described above. In addition, according to a result of the determination, cloud federation information regarding the file requested to be executed or the file included in the list of files to be displayed may be output. Outputting of federation information may be performed by a federation information output control unit (e.g., federation information output control unit 115 in FIG. 2).

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A file management method, comprising:
receiving a request for deleting a first file stored in a mobile device;
determining whether a second file corresponding to the first file is stored in a cloud storage server;
configuring the second file for storage in the cloud storage server based on the determination; and
deleting the first file from the mobile device,
wherein the second file is retained in the cloud storage server after the first file is deleted.

2. The file management method of claim 1, wherein, if the second file is determined not to be stored in the cloud storage server, determining whether to generate the second file for storage in the cloud storage server.

3. The file management method of claim 2, wherein the determination of whether to generate the second file is based on a user response.

4. The file management method of claim 1, wherein, if the second file is determined not to be stored in the cloud storage server, generating the second file and storing the second file in the cloud storage server.

5. The file management method of claim 1, further comprising:
determining a storage type of the second file.

6. The file management method of claim 5, wherein the storage type includes a synchronization type and a backup type.

7. The file management method of claim 6, wherein if the storage type of the second file is determined to be the synchronization type, determining whether to change the storage type of the second file to the backup type.

8. The file management method of claim 7, wherein the determination of whether to change the storage type is based on a user response.

9. The file management method of claim 6, wherein if the storage type of the second file is determined to be the synchronization type, changing the storage type of the second file to the backup type.

10. The file management method of claim 1, further comprising:
outputting cloud federation information related to the first file,
wherein the cloud federation information is used to determine whether the second file is stored in the cloud storage server.

11. The file management method of claim 10, wherein the cloud federation information is displayed with the first file.

12. The file management method of claim 10, wherein the cloud federation information comprises at least one of device information, command information, file information, and device state information.

13. The file management method of claim 1, further comprising:
displaying a list of files capable of being selected for deletion, the list of files comprising the first file.

14. The file management method of claim 1, wherein the second file is a copy of the first file.

15. A mobile device, comprising:
a memory unit to store a first file;
a communication unit to receive a request to delete the first file; and
a control unit to determine whether a second file corresponding to the first file is stored in a cloud storage server, to configure the second file for storage in the cloud storage server based on the determination, and to delete the first file,
wherein the second file is retained in the cloud storage server after the first file is deleted.

16. The mobile device of claim 15, wherein, if the second file is determined not to be stored in the cloud storage server, the control unit determines whether to generate the second file for storage in the cloud storage server.

17. The mobile device of claim 15, wherein the control unit determines a storage type of the second file.

18. The mobile device of claim 17, wherein if the storage type of the second file is determined to be a synchronization type, the control unit determines whether to change the storage type of the second file to a backup type.

19. The mobile device of claim 15, further comprising:
an output unit to display cloud federation information related to the first file,
wherein the cloud federation information is displayed with the first file.

20. A file management method, comprising:
receiving a request for deleting a first file stored in a mobile device;
determining whether a second file corresponding to the first file is stored in a cloud storage server;
generating the second file for storage in the cloud storage server if the second file is determined not to be stored in the cloud storage server;
modifying the storage type of the second file for retaining the second file regardless of the first file if the second file is determined to be stored in the cloud storage server; and
deleting the first file from the mobile device,
wherein the second file is retained in the cloud storage server after the first file is deleted.

21. A mobile device capable of providing a cloud federation service, the mobile device comprising:
a memory unit to store a first file;
a cloud federation determination unit to determine whether the first file is synchronized with a second file stored in a cloud storage server, the second file corresponding to the first file; and
a federation information output control unit to control cloud federation information to be output based on the determination.

22. A file management method for providing a cloud federation service in a mobile device, the file management method comprising:
receiving a request to retrieve a first file stored in the mobile device;
determining whether a second file is stored in a cloud storage server, the second file corresponding to the first file; and
outputting cloud federation information corresponding to the first file based on the determination.
